(19) United States
(12) Patent Application Publication
(10) Pub. No.: US 2007/0097572 A1
(43) Pub. Date: May 3, 2007

(54) Protective circuit

(75) Inventor: Bin Wu, San Jose, CA (US)

Correspondence Address: MACPHERSON KWOK CHEN & HEID LLP, 2033 GATEWAY PLACE, SUITE 400, SAN JOSE, CA, 95110, US

(73) Assignee: Caretta Integrated Circuits

(21) Appl. No.: 11/262,542

(22) Filed: Oct. 28, 2005

(51) Int. Cl. H02H 3/00

(52) U.S. Cl. 361/82

(57) ABSTRACT

A protective circuit for a battery includes: (1) an MOS transistor having a first drain/source terminal coupled to one terminal of the battery; (2) a switch selectable to couple the bulk terminal of the MOS transistor to (a) the first drain/source terminal, (b) a second drain/source terminal, or (c) float; and (3) a control circuit which provides control signals for the gate terminal of the MOS transistor and the switch. By allowing the bulk terminal to float during normal operation (i.e., charging or discharging operation), a sensitive, low-power comparator used in the prior art is eliminated, thereby allowing the protective circuit to have a small foot-print. The protective circuit may further include a resistor. The switch connects the bulk terminal of the MOS transistor to the first drain/source terminal through this first resistor, thereby limiting any “rush” current which occurs when the battery circuit switches from discharging to charging, or vice versa, over a very short time period. Consequently, safe operation of the battery circuit is achieved.

### BACKGROUND OF THE INVENTION

1. Field of the Invention

The present invention relates to a protective circuit for a rechargeable battery. In particular, the present invention relates to a low-power, low “rush current” protective circuit suitable for use with a lithium ion battery or lithium ion polymer battery.

2. Discussion of the Related Art

Lithium ion batteries and lithium polymer batteries are widely use in portable electronic devices because of their high energy density per unit weight or per unit volume. However, if not properly used, they can be hazardous. In some instances, inadvertent large discharge currents or large charging currents have been known to cause fire or even explosion. Therefore, as a safety measure, each lithium ion battery or lithium polymer battery is always provided a protective circuit that limits the current drawn from the battery in the event of an unusual or abnormal operating condition occur. Because the protective circuit is always operating, regardless of whether or not a load is connected across the battery, a practical protective circuit cannot be allowed to draw more than a few microamperes of current.

A protective circuit for a battery typically has the following states: (a). the on state, in which the switch is closed to allow normal discharging or charging currents to flow, and the total on-resistance Rₜₒₜₐₗ is no more than a few tens of milli-ohms; (b) a charging-only state, in which current flows in the charging direction is allowed and current flows in the discharging direction is blocked; and (c) A discharging-only state, in which current flows in the discharging direction is allowed but current flows in the charging direction is blocked.

FIG. 1 illustrates schematically protective circuit 100 used in a rechargeable battery in the prior art. At this time, protective circuit 100 of FIG. 1 is the most widely used protective circuit in portable electronic devices. As shown in FIG. 1, protective circuit 100 includes control circuit 101 and metal-oxide-semiconductor field effect transistors (MOSFETs) 102 and 103. As shown in FIG. 1, MOSFETs 102 and 103 are shown connected in a common-drain configuration in series with battery 105, with their gate terminals being controlled by control circuit 101. Battery 105 is typically a lithium ion battery or a lithium polymer battery. Parasitic diodes 104a and 104b are also expressly shown in FIG. 1 for illustrative purpose. During a discharging operation, a load (e.g., load 107) is connected across terminals 106a and 106b. During a charging operation, a charger (e.g., charger 108) is connected across terminals 106a and 106b. Two MOSFETs are used to allow current to be completely switched off, either during charging and discharging.

In a typical implementation, protective circuit 100 is mounted on a printed circuit board, with MOSFETs 102 and 103 provided in a single package, and control circuit 101 provided in a separate integrated circuit. Because the bulk (or substrate) terminals of MOSFET 102 and 103 are common with their respective source terminals, parasitic diodes 104a and 104b of MOSFETs 102 and 103 each allow current flow from its respective source terminal to its drain terminal, even when the voltage applied to its gate terminal is below its threshold voltage.

In protective circuit 100, MOSFETs 102 and 103 are sized to achieve a low total resistance Rₜₒₜₐₗ, which is equal to the sum of the MOSFETs' individual on-resistance (R_{ds(on)}). Hence, each R_{ds(on)} equals ½ Rₜₒₜₐₗ. As the on-resistance of a MOSFET is inversely proportional to the device area on the semiconductor substrate (“die area”), the total die area for MOSFETs 102 and 103 is roughly four times the size of an alternative “single-MOSFET” protective circuit, which is discussed next.

FIG. 2 shows protective circuit 200, which includes control circuit 74, MOSFET 78 and switches 82 and 86. Protective circuit 200 is disclosed in U.S. Pat. No. 6,670,790 to Stellberger, entitled “Power Switch for Battery Protection”, which was filed on Dec. 14, 2001 and issued on Dec. 30, 2003. As shown in FIG. 2, MOSFET 76 is connected in series with battery 105, with its gate terminal being controlled by control circuit 74. Battery 70 is typically a lithium ion battery or a lithium polymer battery. Parasitic diodes 97 and 98 are also expressly shown in FIG. 2 for illustrative purpose. During a discharging operation, a load (e.g., load 88) is connected across terminals 99 and 94. During a charging operation, a charger (e.g., charger 90) is connected across terminals 99 and 94.

The bulk terminal of MOSFET 78 in protective circuit 200 is difficult to control because of the bulk-to-source junction and the bulk-to-drain junction. If either of these junctions become forward biased, the parasitic lateral and vertical bipolar transistors may become conducting and the resulting current may be detrimental. To prevent these junctions to become forward biased, switches 82 and 86 are controlled such that the bulk terminal of MOSFET 78 is connected to the source terminal or the drain terminal of MOSFET 78, whichever has the lower potential.

One disadvantage of protective circuit 200 is its requirement that control circuit 74 monitors the current direction during both charging and discharging operations, so as to determine which one of the source and drain terminals of MOSFET 78 has the lower potential. This determination may be difficult sometimes. Because the on-resistance R_{ds(on)} of MOSFET 78 is in the range of tens of milliohms, and the current drawn from the battery is typically between a few microamps (μA) to about 1 ampere (A), the voltage drop across the source and drain terminals of MOSFET 78 is less than a few tens of millivolts (mV). Consequently, protective circuit 200 must include a high-precision comparator. Such a comparator requires precious die area and draws a significant operating current.

Another disadvantage of protective circuit 200 occurs when battery 70 switches from discharging to charging, or vice versa. During the switch over, switches 82 and 86 must operate in a coordinated fashion to switch the bulk terminal of MOSFET 78 from its source terminal to its drain terminal, or vice versa. This condition is illustrated by FIG. 3. In FIG. 3, representing a discharging operation, switch 82 is closed and switch 86 is open. Switch 82 shorts the bulk terminal of MOSFET 78 to terminal 96 to avoid forward biasing parasitic diode 97. If battery 70 is over-discharged through load 88, the voltage on gate terminal of MOSFET 78 falls below the threshold voltage, and may even be close to the ground voltage. As a result, MOSFET 78 is non-conducting. If charger 90 is engaged at this point to recharge to depleted battery, switch 82 must open and switch 86 must close within a very short period of time to connect the bulk terminal of MOSFET 78 to terminal 94 to prevent forward biasing parasitic diode 98. However, because protective circuit 200 typically draws only a few μA of current, protective circuit 200 cannot respond very quickly—perhaps requiring a few hundred micro-seconds (μs)—to this sudden change from a discharging operation to a charging operation. In the meantime, a large current flows in switch 82 and parasitic diode 98. This large current may result in circuit latch-up and other undesirable or detrimental effects. This large current may also be hazardous, from the viewpoint of safety.

Thus, a safe, low power protective circuit which requires a small die area is desired.

### SUMMARY

According to one embodiment of the present invention, a protective circuit for a battery includes: (1) an MOS transistor having a first drain/source terminal coupled to one terminal of the battery; (2) a switch selectable to couple the bulk terminal of the MOS transistor to (a) the first drain/source terminal, (b) a second drain/source terminal, or (c) float; and (3) a control circuit which provides control signals for the gate terminal of the MOS transistor and the switch. By allowing the bulk terminal to float during normal operation (i.e., charging or discharging operation), a precision, low-power comparator used in the prior art is eliminated, thereby allowing the protective circuit to have a small foot-print.

In one embodiment, the protective circuit further includes a resistor. The switch connects the bulk terminal of the MOS transistor to the first drain/source terminal through this first resistor, thereby limiting any “rush” current which occurs when the battery circuit switches from discharging to charging, or vice versa, over a very short time period. Consequently, safe operation of the battery circuit is achieved.

In accordance with another embodiment of the present invention, a protective circuit for a battery includes: (1) an MOS transistor having a first drain/source terminal coupled to one terminal of the battery; (2) a switch selectable to couple the bulk terminal of the MOS transistor to (a) the first drain/source terminal, or (b) a second drain/source terminal; and (3) a control circuit which provides control signals for the gate terminal of the MOS transistor and the switch. In this embodiment, while a low-power comparator is required in the control circuit, the protective circuit may further include a resistor, which operates to limit any “rush” current that occurs when the battery circuit switches from discharging to charging, or vice versa, over a very short time period. Consequently, safe operation of the battery circuit is also achieved.

The present invention is better understood upon consideration of the detailed description below and the accompanying drawings.

### BRIEF DESCRIPTION OF THE DRAWINGS

FIG. 1 illustrates schematically protective circuit 100 used in a rechargeable battery in the prior art.

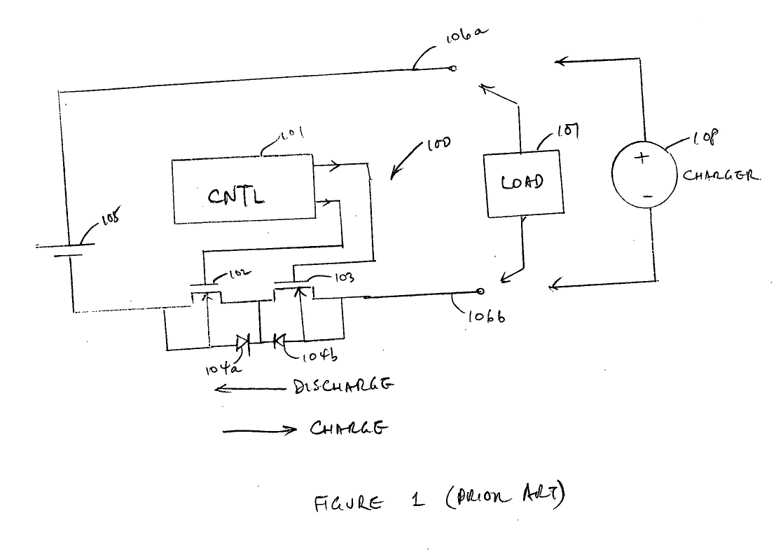

FIG. 2 illustrates schematically protective circuit 200 used in a rechargeable battery in the prior art.

FIG. 3 illustrates the operation of protective circuit 200 of FIG. 2 during a switch over from discharging to charging.

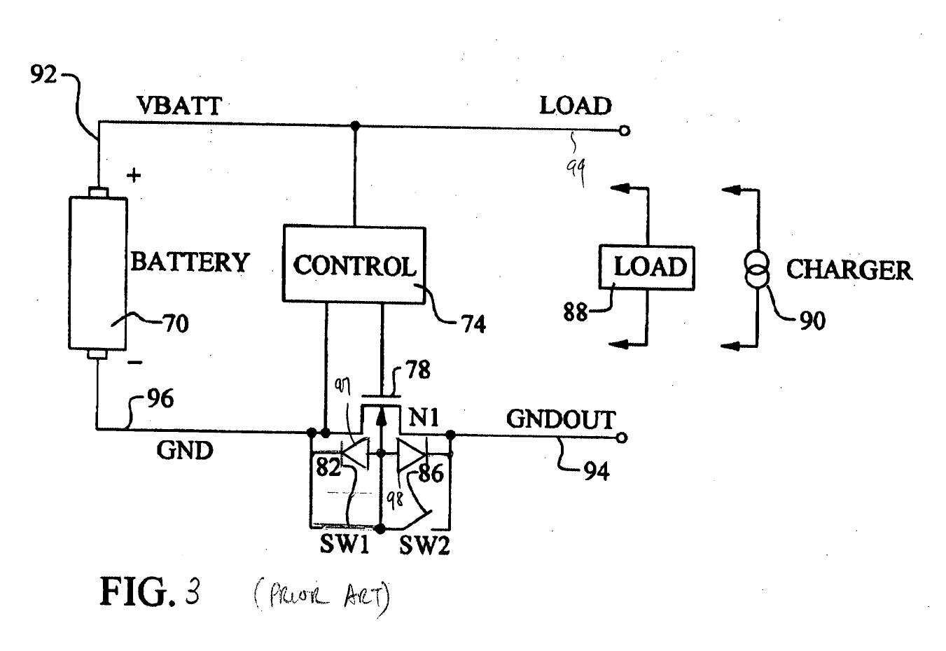

FIG. 4 shows protective circuit 400, in accordance with one embodiment of the present invention.

FIG. 5 shows protective circuit 500, in accordance with a second embodiment of the present invention.

To facilitate cross-referencing and to simplify the detailed description, like elements in the figures are provided like reference numerals.

### DETAILED DESCRIPTION OF THE PREFERRED EMBODIMENTS

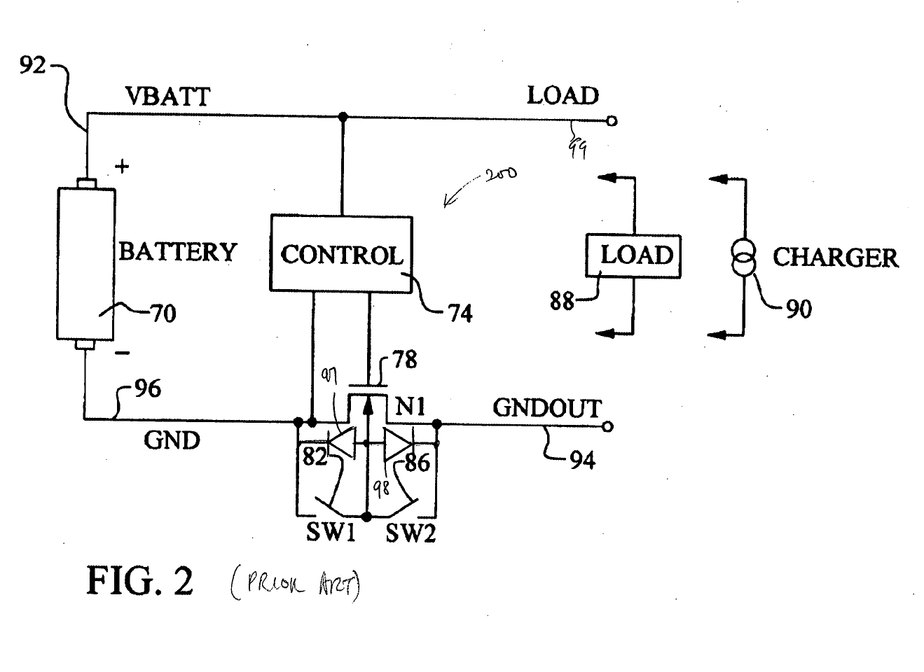

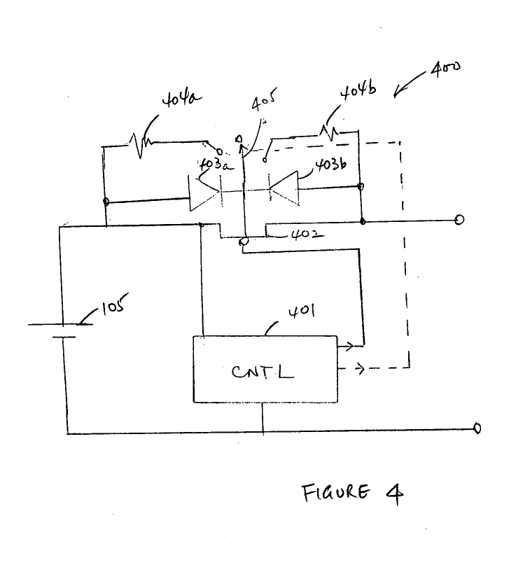

FIG. 4 shows protective circuit 400, in accordance with one embodiment of the present invention. As shown in FIG. 4, protective circuit 400 includes control circuit 401, MOSFET 402, resistors 404a and 404b, and switch 405. MOSFET 402 includes parasitic diodes 403a and 403b, corresponding respectively to the junctions at its source and drain terminals. Under control of control circuit 401, switch 405 can selectively float the bulk terminal of MOSFET 402, or to connect the bulk terminal of MOSFET 402 to its source terminal or its drain terminal, through resistors 404a and 404b, respectively. During normal operation (i.e., either in a discharging operation or a charging operation), the bulk terminal of MOSFET 402 is allowed to float. Unlike protective circuit 200 of FIG. 2, by floating the bulk terminal of MOSFET 402, protective circuit 400 is not required to detect whether the operation is charging or discharging (hence, there is no need to determine which one of the drain terminal and the source terminal is at a lower potential). Accordingly, control circuit 401 does not require a precision comparator.

During a change from a discharging operation to a charging operation, or vice versa, switch 405 is switched to connect the bulk terminal of MOSFET 402 to the drain terminal or the source terminal of MOSFET 402 thorough resistor 404a or resistor 404b, so as to limit the current in parasitic diode 403b or parasitic diode 404a, respectively. The appropriate resistance values should limit the current in each of the parasitic diodes to no more than a few milliamps (mA). Such a current normally does not cause catastrophic destruction in the integrated circuit. In one embodiment, resistors 404a and 404b are integrated into switch 405 by properly sizing the MOS switches.

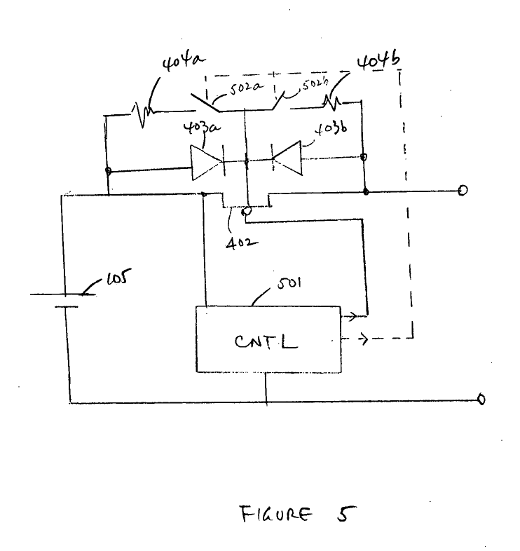

FIG. 5 shows protective circuit 500, in accordance with a second embodiment of the present invention. As shown in FIG. 5, protective circuit 500 includes control circuit 501, MOSFET 402, resistors 404a and 404b, and switches 502a and 502b. As discussed above, MOSFET 402 includes parasitic diodes 403a and 403b, corresponding respectively to the junctions at its source and drain terminals. Under control of control circuit 501, switches 502a and 502b selectively connect the bulk terminal of MOSFET 402 to its source terminal or its drain terminal, through resistors 404a and 404b, respectively. Like protective circuit 200 of FIG. 2, without a float setting, control circuit 501 includes a comparator circuit to detect which one of the source terminal and the drain terminal of MOSFET 402 has a lower potential, so as to allow switches 502a and 502b to connect the bulk terminal of MOSFET 402 to either its source terminal or its drain terminal. In this embodiment, the resistors 404a and 404b are sized, as discussed above, according to the expected rush currents in parasitic diodes 403b and 403a, respectively.

The detailed description above is provided to illustrate the specific embodiments of the present invention and is not intended to be limiting. Numerous modifications and variations within the scope of the present invention are possible. The present invention is set forth in the claims below.

I claim:

1. A protective circuit for a battery, comprising:
an MOS transistor having a bulk terminal, a gate terminal, a first drain/source terminal and a second drain/source terminal, wherein the first drain/source terminal is coupled to one terminal of the battery;
a switch selectable to couple the bulk terminal of the MOS transistor to (a) the first drain/source terminal, (b) the second drain/source terminal, or (c) float; and
a control circuit which provides control signals for the gate terminal of the MOS transistor and the switch.

2. A protective circuit as in claim 1, further comprising a first resistor, wherein the switch connects the bulk terminal of the MOS transistor to the first drain/source terminal through the first resistor.

3. A protective circuit as in claim 2, further comprising a second resistor, wherein the switch connects the bulk terminal of the MOS transistor to the second drain/source terminal through the second resistor.

4. A protective circuit as in claim 1 wherein, during normal operation, the switch floats the bulk terminal of the MOS transistor.

5. A protective circuit as in claim 1, a load is to be provided between the other terminal of the battery and the second drain/source terminal of the MOS transistor.

6. A protective circuit for a battery, comprising:
an MOS transistor having a bulk terminal, a gate terminal, a first drain/source terminal and a second drain/source terminal, wherein the first drain/source terminal is coupled to one terminal of the battery;
a switch selectable to couple the bulk terminal of the MOS transistor to (a) the first drain/source terminal, (b) the second drain/source terminal;
a first resistor in series with the switch, such that the bulk terminal of the MOS transistor is connected to the first drain/source terminal through the first resistor; and
a control circuit which provides control signals for the gate terminal of the MOS transistor and the switch.

7. A protective circuit as in claim 6, further comprising a second resistor, wherein the switch connects the bulk terminal of the MOS transistor to the second drain/source terminal through the second resistor.

8. A protective circuit as in claim 6, wherein the control circuit comprises a comparator circuit that controls at any given time whether the bulk terminal of the MOS transistor is connected to the first drain/source terminal or the second drain/source terminal.

9. A protective circuit as in claim 6, a load is to be provided between the other terminal of the battery and the second drain/source terminal of the MOS transistor.

10. A method for protecting a battery, comprising:
Connecting a first drain/source terminal of an MOS transistor to one terminal of the battery, wherein the MOS transistor has a bulk terminal, a gate terminal, the first drain/source terminal and a second drain/source terminal;
Providing a switch selectable to couple the bulk terminal of the MOS transistor to (a) the first drain/source terminal, (b) the second drain/source terminal, or (c) float; and
generating control signals for the gate terminal of the MOS transistor and the switch.

11. A method as in claim 10, wherein the switch connects the bulk terminal of the MOS transistor to the first drain/source terminal through a first resistor.

12. A method as in claim 11, wherein the switch connects the bulk terminal of the MOS transistor to the second drain/source terminal through a second resistor.

13. A method as in claim 10 wherein, during normal operation, the switch floats the bulk terminal of the MOS transistor.

14. A method as in claim 10, further comprising providing a load between the other terminal of the battery and the second drain/source terminal of the MOS transistor.

15. A method for protecting a battery, comprising:
Connecting a first drain/source terminal of an MOS transistor to one terminal of the battery, wherein the MOS transistor has a bulk terminal, a gate terminal, the first drain/source terminal and a second drain/source terminal;
Providing a switch selectable to couple the bulk terminal of the MOS transistor through a first resistor to (a) the first drain/source terminal, (b) the second drain/source terminal; and
Providing control signals for the gate terminal of the MOS transistor and the switch.

16. A method as in claim 16, wherein the switch connects the bulk terminal of the MOS transistor to the second drain/source terminal through a second resistor.

17. A method as in claim 16, wherein a comparator circuit controls at any given time whether the bulk terminal of the MOS transistor is connected to the first drain/source terminal or the second drain/source terminal.

18. A method as in claim 16, providing a load between the other terminal of the battery and the second drain/source terminal of the MOS transistor.
